(19) United States
(12) Patent Application Publication
(10) Pub. No.: US 2026/0217995 A1
(43) Pub. Date: Jul. 30, 2026

(54) DEHAZING COATINGS AND METHOD FOR USE

(71) Applicant: SUN CHEMICAL B.V., Weesp (NL)

(72) Inventors: Marieanne HURST, Rochdale, Lancashire (GB); Joanne GUITE, Rochdale, Lancashire (GB)

(73) Assignee: SUN CHEMICAL B.V., Weesp (NL)

(21) Appl. No.: 19/146,721

(22) PCT Filed: Jan. 26, 2024
(86) PCT No.: PCT/GB2024/050214

§ 371 Date: Jul. 9, 2025

Related U.S. Application Data
(60) Provisional application No. 63/441,257, filed on Jan. 26, 2023.

(51) Int. Cl. C09D 11/14; B41M 1/26; B41M 3/00; B65D 65/42; C08J 7/04; C08J 7/048; C09D 11/033; D21H 19/12

(52) U.S. Cl. CPC C09D 11/14; B41M 1/26; B41M 3/006; B65D 65/42; C08J 7/0427; C08J 7/048; C09D 11/033; D21H 19/12; C08J 2301/02; C08J 2405/00

(57) ABSTRACT

A method for enhancing the transparency of substrates, particularly papers having a degree of translucency, with the use of water-based coatings comprising polysaccharide resins. The invention also relates to a method of heat-sealing said substrates using said polysaccharide resins.

### FIELD OF THE INVENTION

The invention relates to methods and uses of water-based polysaccharide coatings for increasing the transparency of transparent or translucent paper or plastic substrates. The invention also relates to methods and uses of said water-based polysaccharide coatings for heat-sealing said substrates.

### BACKGROUND OF THE INVENTION

IO Plastic (filmic) substrates are commonly used as part of both non-direct and direct food contact packaging products, where visibility of items inside the sealed package is required. These thin-layer substrates are often used as windows or lids in giftbox or punnet applications, for example. However, there are issues around the use of plastic films in food packaging and other packaging applications, even where these plastics are derived from sustainable and/or biorenewable sources.

Many plastics are not biodegradable (or compostable) and, as especially in the case of plastic laminates, can be difficult to recycle. In particular, even plastics derived from biorenewable sources can be difficult to recycle, as the recycling industry is currently directed towards recycling plastics derived from fossil fuels. Furthermore, use of such plastics can result in microplastic build-up on land, oceans, and in the air, which contributes to damaging effects to both ecological and human health, especially if such microplastics enter food chains. This is a real concern, as currently at least 10 million tons of plastic waste enter the Earth's oceans every year.

As a result, there is higher demand for paper and board substrates, which provide a more sustainable and less environmentally damaging approach to food packaging. Most of these substrates are opaque in appearance due to air cavities present in the cellulose matrix, but translucent papers and cellophane are found in the paper industry, which can potentially be used in the applications areas stated above. However, the processing of cellophane is extensive and requires the use of hazardous chemicals like carbon disulfide to achieve its transparency.

Translucent papers can be made using less harsh methods, but these papers lack adequate optical clarity and have different degrees of haze in relation to density and thickness. In particular, translucent papers are well known in the packaging industry and may be referred to as vellum papers. Translucency is achieved by eliminating the majority of the air trapped in a paper, as this entrapped air leads to paper's opacity. Although such vellum papers have a degree of translucency, they are not sufficiently transparent to allow the contents of packaged goods, and especially foodstuffs such as fresh foodstuffs, to be satisfactorily viewed.

Cellulose films may have some surface resistance properties but often have thin layer coatings or treatments to further enhance these properties, which may affect whether these films and can used in direct food contact application and/or whether these films are sustainable. Moreover, these thin cellulosic/paper substrates also have no heat-seal capability when used alone. Consequently, this means polymeric adhesives may be required to bond them to box/punnet type packaging as viewing windows, which May incur extra processing and could affect overall biodegradability of the final engineered product.

The present invention addresses these issues in the art, providing an environmentally benign alternative to plastic packaging. In particular, the present invention enhances the transparency of substrates (e.g., vellum papers) to a point that packaged goods can be easily seen.

### Background Documents

WO2022003472A1 refers to a barrier coating comprising anionic polysaccharides.

US20140230691 refers to how a thermoplastic coating can be prepared from fatty acid modified hemicelluloses. WO2021/019468, U.S. Pat. No. 7,427,643B2 and U.S. Pat. No. 8,557,033B2 refer to oxygen barrier coatings compnsmg hemicelluloses, and secondary plasticizers or hydrophobizing agents, wherein said plasticizers or hydrophobizing agents may also be used in the present invention.

U.S. Pat. No. 10,934,448B2, U.S. Pat. No. 9,878,839B2, U.S. Pat. No. 6,066,368B2 and U.S. Pat. No. 8,734,959B2 relate to barrier coatings comprising starches. Various additional components may be used to enhance the barrier performance further, including hydrophobizing agents, plasticizers and clays. WO2018200783 refers to heat-sealable coatings based on styrene-acrylic polymers and waxes and is representative of the state of the art concerning coatings based on petrochemically derived raw materials.

DE102021125162 refers to a flat fibrous packaging material comprising at least one fibrous layer, wherein between the fibers of the at least one fibrous layer free spaces of fibers are formed, wherein the packaging material extends in a thickness direction as a smallest dimension and in two main extension directions orthogonal to each other and to the thickness direction.

None of these references describe how coatings compnsmg polysaccharides, having Refractive Indices (R1s) matched to those of the (e.g., paper) substrate (especially vellum papers), can be used to enhance the optical clarity (i.e., transparency) of the substrates, such as paper. Furthermore, the further use of these coatings in heat-sealing has not been disclosed in the prior art, particularly at temperatures of less than 150° C. There are hundreds of references to the use of polysaccharides in paper barrier coatings. However, there are no instances of the use of these coatings in heat-sealing applications that also enhance the optical clarity of substrates (e.g., paper packaging).

### SUMMARY OF THE INVENTION

The invention provides a method of increasing the transparency of a substrate, comprising: a) applying a water-based polysaccharide coating to a transparent or translucent paper or plastic substrate to form a coated substrate, wherein the refractive index of the dry coating is within 10% of the substrate.

The invention further provides the use of a water-based polysaccharide coating for increasing the transparency of a substrate; wherein the substrate is a transparent or translucent paper or plastic substrate; characterized in that the refractive index of the dry coating of said water-based polysaccharide is within 10% of the refractive index of the substrate; and wherein the use comprises: a) applying the water-based polysaccharide coating to the substrate to form a coated substrate.

The invention may also provide a method of increasing the transparency of a substrate, comprising: a) applying a water-based polysaccharide coating to a paper or plastic substrate, such as a paper substrate, to form a coated substrate, wherein the refractive index of the dry coating is within 10% of the substrate; and wherein the uncoated substrate has a total visible light transmittance of at least 70%, such as at least 80% or at least 90%.

The invention further provides the use of a water-based polysaccharide coating for increasing the transparency of a substrate; wherein the substrate is a paper or plastic substrate, such as a paper substrate, characterized in that the refractive index of the dry coating of said water-based polysaccharide is within 10% of the refractive index of the substrate; and wherein the use comprises: a) applying the water-based polysaccharide coating to the substrate to form a coated substrate; and wherein the uncoated substrate has a total visible light transmittance of at least 70%, such as at least 80% or at least 90%.

The invention further provides a method of heat-sealing a transparent or translucent paper or plastic substrate, comprising the steps of a) applying a water-based polysaccharide coating to the substrate to form a coated substrate, wherein the refractive index of the dry coating of the water-based polysaccharide is within 10% of the refractive index of the substrate; b) forming a bonding region by contacting the coated substrate with itself or a second substrate; c) applying heat and pressure to the bonding region to form a seal, optionally a hermetic seal, wherein the heating temperature is from 60° C. to 200° C.

The invention further provides the use of a water-based polysaccharide coating for heat-sealing a substrate, wherein the substrate is a transparent or translucent paper or plastic substrate; and wherein the use comprises: a) applying a water-based polysaccharide coating to the substrate to form a coated substrate; wherein the refractive index of the dry coating of the water-based polysaccharide is within 10% of the refractive index of the substrate; b) forming a bonding region by contacting the coated substrate with itself or a second substrate; c) applying heat and pressure to the bonding region to form a seal, optionally a hermetic seal, wherein the heating temperature is from 60° C. to 200° C.

The invention further provides a method of heat-sealing a paper or plastic substrate, such as a paper substrate, wherein the uncoated substrate has a total visible light transmittance of at least 70%, such as at least 80% or at least 90%, the method comprising the steps of a) applying a water-based polysaccharide coating to the substrate to form a coated substrate, wherein the refractive index of the dry coating of the water-based polysaccharide is within 10% of the refractive index of the substrate; b) forming a bonding region by contacting the coated substrate with itself or a second substrate; c) applying heat and pressure to the bonding region to form a seal, optionally a hermetic seal, wherein the heating temperature is from 60° C. to 200° C.

The invention further provides the use of a water-based polysaccharide coating for heat-sealing a substrate, wherein the substrate is a paper or plastic substrate, such as a paper substrate, wherein the uncoated substrate has a total visible light transmittance of at least 70%, such as at least 80% or at least 90%, and wherein the use comprises: a) applying a water-based polysaccharide coating to the substrate to form a coated substrate; wherein the refractive index of the dry coating of the water-based polysaccharide is within 10% of the refractive index of the substrate; b) forming a bonding region by contacting the coated substrate with itself or a second substrate; c) applying heat and pressure to the bonding region to form a seal, optionally a hermetic seal, wherein the heating temperature is from 60° C. to 200° C.

### BRIEF DESCRIPTION OF FIGURES

FIG. 1—diagrammatic representation of polysaccharides, including sub-groups thereof based on the number of sugar units.

FIG. 2—Pictures demonstrating the increased transparency and reduced haze provided by the present invention. FIG. 2 depicts how the visibility of packaged contents (e.g., fresh produce-see photos on left hand side) is poor when the contents is covered by an uncoated paper substrate (middle photos; top=32 g/m² paper, bottom=50 g/m² paper), but how visibility is improved when replacing the substrate with a coated substrate obtained from the present invention (right photos; top=32 g/m² paper with a coating for use in the invention, bottom=50 g/m² paper with a coating for use in the invention). OPV=OverPrint Varnish, i.e., a coating layer obtained from the coating for use in the invention.

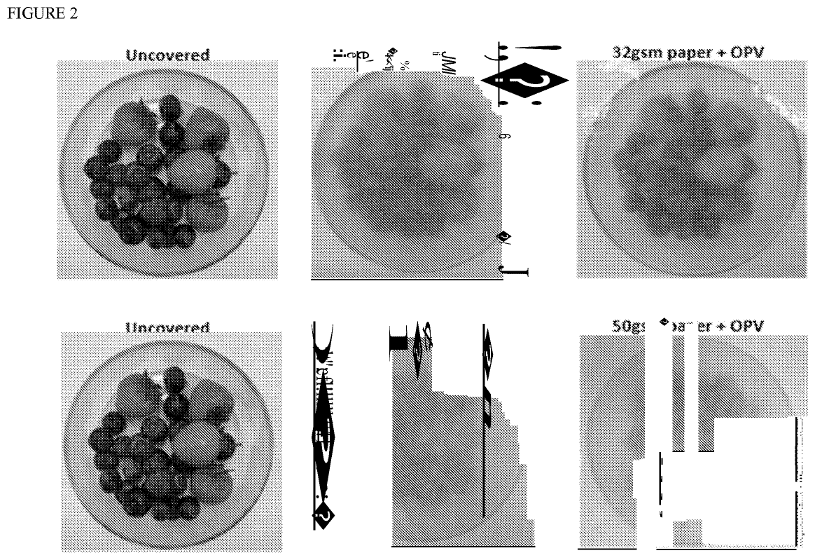

### DETAILED DESCRIPTION OF THE INVENTION

### Definitions

Increasing transparency=increasing the total visible light transmission through the substrate by at least 2%, but more preferably by at least 3%, at least 5%, or at least 10%.

Transparent Substrate=a substrate with a total visible light transmission of at least 80%. Total visible light transmission is measured according to the method described in the examples.

Translucent substrate=allows light to pass through but diffuses said light so that images viewed through the substrate are not clearly visible.

MAP=Modified Atmospheric Packaging. A widely used technology in the packaging industry, where food packaging is flushed with gases that extend the shelf-life of the packaged produce.

Fumaric Resin=a resin derived from rosin, modified with fumaric acid and partially esterified with glycerin.

Non-chemically modified=a naturally derived material that has not undergone chemical modification.

Nanoclays=nanoparticles of layered mineral silicates

Cellophane=a thin, transparent sheet made of regenerated cellulose. Cellulose from wood, cotton, hemp, or other sources is dissolved in alkali and carbon disulfide to make a solution called viscose, which is then extruded through a slit into a bath of dilute sulfuric acid and sodium sulfate to reconvert the viscose into cellulose. The film is then passed through several more baths, one to remove sulfur, one to bleach the film, and one to add softening materials such as glycerin to prevent the film from becoming brittle.

Room temperature=25° C.

(w/w)=mass of component as a percentage of the total mass of the composition.

Direct food contact (DFC) inks and coatings (including OPVs)=compositions intended to be in direct physical contact with food, for instance in food packaging. Thus, DFC inks and coatings may be used on the inside of food packaging. For DFC applications, the diffusion path between ink or coating and food is short, and so DFC inks or coatings have a greater potential for migration into the food compared to non-direct food contact (non-DFC) inks, which are used on the non-food contact surfaces of food packaging or other articles. The term “non-direct food contact” is also referred to as “indirect food contact” and describes a material (such as an ink or coating) which has a functional barrier layer between it and the food substance, wherein there is reduced potential for the material to come into contact with food. An example of an indirect food contact ink is an ink applied to the outside of food packaging or to an intermediate layer of food packaging. Although there is a potential for migration from non-DFC inks, it is lower than the risk with DFC inks and coatings.

Heat-sea/ability=the ability of a packaging film to form a seal in a formed package when subjected to heat and pressure, e.g., a hermetic seal.

Hermetic seal=any type of sealing that makes a given object airtight.

Water-solubility=the amount of a compound or composition that is fully dissolvable in 100 g water at ambient temperature (20° C.). Thus, 5% water-solubility corresponds to 5 g of a compound or composition fully dissolving in 100 g of water at 20° C.

Fully dissolved=when the mixture of water and compound or composition is transparent after 30 minutes at 20° C. with stirring.

Transparent solution=when it is possible to read text on a printed sheet of paper through the solution (from every angle).

A-to-A heat-seals=wherein both substrates that are bonded together to form a heat seal comprise a coating of adhesive prior to heat seal formation.

Self-cross/inking polymers=polymers containing a functionality which is self-reactive, and thus do not require the use of a separate co-reactant per se. A self-crosslinking polymer is usually in the form of an aqueous dispersion or emulsion and is typically the product of at least two monomers that react with one another. For example, such a polymer may contain both a carbonyl and an amine functional group. There are several mechanisms by which a polymer can be self-crosslinking. Alternatively, or in addition, self-crosslinking polymer emulsions can comprise crosslinkable functional groups attached to the polymer backbone in addition to a crosslinker (i.e., a polyfunctional species that reacts with said crosslinkable functional groups). Typically, in self-crosslinking polymer chemistry, polymers containing ketone groups crosslink at room temperature when combined with bi-or polyfunctional compounds that are reactive towards carbonyl. One example of these reactive compounds is bishydrazides. Such self-crosslinking PUDs are provided as one pack products.

The self-crosslinking reaction may also be initiated by the evaporation of water upon drying, a change of pH of the vehicle, or by curing at elevated temperatures, at which the cross-linking reaction occurs faster, or the reactive groups are de-blocked. In a preferred embodiment, the self-crosslinking polymers used in the present invention undergo self-crosslinking at room temperature (e.g., 25° C.). In other words, self-crosslinking polymers and polymer emulsions are species that undergo crosslinking when initiated by one of the above-mentioned methods, but otherwise can be stored long-term in a stable state without undergoing significant crosslinking. Self-crosslinking polymers and polymer emulsions do not require mixing with a crosslinking agent in order to undergo crosslinking. Tortuosity=the diffusion path length through a coating. Materials such as dispersed (and exfoliated) clays or other plate-like minerals can increase the diffusion path length through a coating, thereby reducing the diffusion rate of a penetrating gas and improving the barrier performance.

Chitin/chitosan=a naturally derived crosslinker comprising amine functionality with the ability to crosslink starches and polysaccharides.

Vellum paper=made of cellulose fibers, which are beaten and processed to remove the air, resulting in dense, translucent sheets.

### The Invention

Described herein are methods for enhancing the transparency of substrates (e.g., papers), particularly those having a degree of translucency, using a water-based polysaccharide coating, such as a corn/rice-derived polysaccharide resin and more specifically maltodextrins. Also described is heat-sealing of substrates using the same water-based polysaccharide coating.

To the best of the inventors' knowledge, this is the first reported instance of a coating based predominantly on raw materials derived from sustainable biorenewable sources, which can enhance the optical transparency of paper packaging and heat-seal. Both these features of the invention are highly advantageous in the preparation of sustainable, biodegradable or recyclable paper-based packaging. It is envisaged that the present invention can be used as a replacement of significant amounts of different plastic packaging.

Furthermore, the coating substrates obtained from the invention can provide barriers to gases, especially oxygen, and offer grease resistance. The enhanced optical clarity, most especially on vellum papers, is particularly advantageous. The aforementioned features of the substrates (e.g., paper packaging) obtained from the present invention provide significant technical advantages over the prior art. Moreover, paper packaging afforded from the present invention will facilitate replacement of plastic packaging prevalent in the industry.

### Advantages Associated with the Invention

### Reducing Haze, Increasing Transparency, BioRenewable Content

The coatings for use in the invention have R1s close to (i.e., within 10% of) the substate (e.g., the cellulose fibres within paper). The inventors have found that matching the RI of the polysaccharide coating with that of the substate (e.g., paper) enhances the transparency, as well as reduces the haze, of the coated substrate (e.g., coated paper). These advantages are quantified via haze and transmission testing, wherein haze can be reduced by 20 to 40% and total visible light transmission can be increased by at least 2%, such as at least 3%. In some instances, total visible light transmission increases of at least 10% may be possible. The percentage change for the haze and total visible light transmission is given as an absolute value, i.e., the difference between each of the actual percentage haze and percentage transmission values measured for the coated and uncoated substrates.

IO The skilled person would understand that increasing the transparency of a substrate can be achieved by applying the coating for use in the invention to a single side of the substrate, wherein the visible light used in the transmission testing is incident on the side of the substrate comprising the coating. Alternatively, increasing the transparency of a substrate is preferably achieved by applying the coating for use in the invention to both sides of the substrate. In this instance, the visible light used in the transmission testing can be incident on either side of the substrate.

The inventors have also found that the chemistry, rheology, and application method of the coating for use in the invention can contribute to an overall reduction in haze and increase in optical transmission of the final product. Enhancement of substrates (e.g., paper packaging, especially that derived from translucent vellum papers) to improve the transparency and to reduce the haze of a finished product by the simple use of a coating that is fully recyclable/compostable is highly desirable.

The invention may also significantly benefit the environment, by reducing reliance on plastic packaging and reducing the amount of plastic waste entering and polluting the environment. Furthermore, the coated substrates (e.g., paper packaging) obtainable from the invention may be recyclable, either as paper or treated as biodegradable packaging. Another additional benefit is that all the raw materials used in the described coating technology may be non-chemically modified, therefore falling out of the scope of SUPD (The Single Use Plastic Directive) and its attendant controls and restrictions.

### Heat-Sealing, Grease Resistance, CO2/O2 Barrier, Overprintability

The inventors have surprisingly found that the coatings for use in the invention have a heat-seal capability, grease resistance, oxygen barrier performance, and overprintability, all of which are advantageous for use in engineered, sustainable food packaging. These additional functional attributes mean that the substrates obtainable from the invention (e.g., paper-based packaging) are a viable alternative to petrochemically derived plastic packaging prevalent in the packaging industry.

The heat-sealability of the coatings for use in the invention is an especially advantageous feature, allowing the substrates (e.g., papers) coated with said coatings to form a seal, such as hermetically sealed packaging. The coatings for use in the invention also have a barrier capability against grease and gases, particularly oxygen and carbon dioxide. These properties are advantageous for the production of food packaging pouches, sealed trays, and the like.

Accordingly, the paper or plastic substrates for use in the present method and use of the invention for heat-sealing substrates may be substantially free of conventional adhesives, for example, the paper or plastic substrates may comprise 10 wt¾ of less of a conventional adhesive, relative to the weight of the substrate, such as 5 wt % or less, or 1 wt % or less, or 0.1 wt % or less, relative to the weight of the substrate. Conventional adhesives include acrylic based emulsions, polyvinyl acetates-, polyvinyl alcohols, combinations of polyvinyl acetates and acrylic emulsions, and combinations thereof.

Moreover, the barrier properties of the substrates obtainable from the invention permit their use in Modified Atmospheric Packaging (MAP), wherein food packaging is flushed with gases that extend the shelf-life of packaged produce. Typically, flushing gases are nitrogen and carbon dioxide mixtures, which exclude most of the oxygen from the package and also make use the biocidal activity of carbon dioxide. For dry foodstuffs, the barrier performance of the coatings for use in the invention is clearly advantageous.

Furthermore, the good grease resistance of the coatings for use in the invention is useful, for example, in packaging of ready meals, such as fresh sandwiches.

The coatings for use in the invention provide water-based, direct food-contact coatings that can be solely based on naturally derived materials. In particular, by selecting polysaccharides that closely match the RI of cellulose fibers distributed in translucent papers (as the substrate) or the RI of the translucent papers themselves (as the substrate), these substrates and coatings can be solely derived from naturally derived materials, i.e., have a BRC of at least 95%, such as 100%.

The heat-sealability of this new coating technology provides a viable alternative to the predominantly synthetic heat-sealing coating technologies employed in the art. The barrier properties previously described in combination with this heat sealability means the coatings for use in the invention are multifunctional. The raw materials incorporated into the coatings for use in the invention are natural and safe, allowing the compositions for use in the invention to be used as both indirect and DFC packaging coatings. These multifunctional coating compositions for use in the invention can simplify the preparation of paper packaging by removing processing steps typically requiring several different coatings and/or adhesives, which is highly advantageous.

Another advantage offered by coatings prepared according to the invention is grease resistance, where the surface repels oil-like substances, especially for more than 8 hours on both folded and flat coated areas. This additional benefit will behave as a preventative measure to oil, or fatty, containing food products causing visible blemishes on the paper packaging or surface markings from fingerprints when being handled in application.

### Method/Use of the Invention

### Increasing the Transparency and Decreasing Haze

The method and use of the invention increase the transparency of transparent or translucent paper or plastic substrates. For the purposes of the present invention, increasing the transparency of a substrate means an increase in the total visible light transmission of at least 2%. Preferably, the increase in total visible light transmission is at least 3%, such as at least 3.4%. In some instances, the total visible light transmission may be increased by at least 10%.

The method and use of the invention also decrease the haze of transparent or translucent paper or plastic substrates. For the purposes of the present invention, decreasing the haze of a substrate means a decrease in haze of at least 20%. Preferably, the decrease in haze is at least 25%, such as at least 28%.

### Method of Coating

The coatings of the invention may be applied by any suitable coating or printing method including, but not limited to, flexographic, gravure, offset, spray, inkjet, and roller coating methods.

The thickness of the coating on the substrate may be from 0.1 to 20 μm. Preferably, the thickness of the coating on the substrate is from 0.5 to 10 μm, such as 1 to 6 μm.

The coating may be applied to the substrate with a coating weight of 1 to 20 g/m². Preferably, the coating is applied to the substrate with a coating weight of 3 to 17 g/m², more preferably 5 to 15 g/m², and even more preferably 5 to 10 g/m₂.

The coating may be applied to one or both sides of the substrate. Preferably, the coating is applied to both sides of the substrate.

### Overprinting

Substrates (e.g., papers) coated with the coatings for use in the invention may subsequently be overprinted with a further material. Materials includes inks, including water-based inks such as flexographic printing inks. The coated substrates afforded from the invention may have a surface energy (SE) of at least 35 J/m², such as at least 40 J/m². Coated substrates having surface energies of less than or equal to 35 mJ/m² are typically very difficult to overprint and require corona treatment to facilitate overprinting.

The coated substrates (e.g., papers) obtainable from the invention, whether they be printed or not, may be subjected to further coating processes, including the application of overprint adhesives, further oxygen or moisture vapour barrier coatings, and/or adhesive layers. The coated substates (e.g., papers) may also be laminated to further paper or plastic layers.

The invention may further comprise the step of overprinting the coating with an additional layer selected from the group consisting of inks, additional coatings, adhesives, and combinations thereof. The substrates obtainable from the invention could be overprinted with subsequent layers of inks and/or coatings, for example, pigmented inks to provide decorative or graphics features, or barrier coatings to further enhance barrier resistance properties, etc. Advantageously, these subsequently applied inks and/or coatings can also have a high BRC, be biodegradable and/or compostable. The inks, additional coatings, adhesives, and combinations thereof used in the overprinting step preferably have a BRC of at least 50%, such as at least 70%, or at least 90%.

The coatings for use in the invention offer excellent overprintability, especially to water-based inks and in particular to those comprising significant content derived from sustainable or biorenewable sources, such as those provided in USI 1352522B2, which are herein incorporated by reference.

### Heat-Sealing

Substrates (e.g., paper packaging) comprising the coatings for use of the invention have surprisingly been found to be heat-sealable. Heat-sealability is a term well understood in the art and refers to the ability of a packaging film to form a seal, e.g., a hermetic seal, in a formed package when subjected to heat and pressure. Typically, sealing temperatures in excess of 150° C. are used.

The inventors have found that substrates (e.g., papers) obtainable from the invention can be heat-sealed at temperatures as low as 60° C., such as 80° C. Heat-sealing packaging at temperatures lower than 150° C. is advantageous, as it is less likely to be deleterious to the substrate and requires less energy.

The invention may thus further comprise using the water-based polysaccharide coating to heat-seal a substrate to itself or a second substrate, comprising the steps of a) applying a water-based polysaccharide coating to said substrate; b) forming a bonding region by contacting said coated substrate with itself or a second substrate; c) applying heat and pressure to the bonding region; wherein the heating temperature is from 60° C. to 200° C., such as 60 to 145° C.; to form a seal, optionally a hermetic seal.

Heat-sealing may be performed at temperatures from 60° C. to 170° C., such as 60° C. to 150° C. or 100° C. to 150° C., preferably 60° C. to 145° C., such as 80 to 140° C., and more preferably 80° C. to 130° C., such as 90° C. to 120° C. Heat-sealing may be performed at pressures of 100 to 10,000 kPa, such as 300 to 7,000 kPa.

The substrates afforded from the invention can be used in lidding applications, replacing plastic laminates, for example lids for cooked meats. Examples of heat-sealable packaging include PET-PE (polyester-polyethene) laminates used in lidding applications, where the laminate film is heat-sealed, via the PE membrane to a tray typically made of polyester. The coated (e.g., paper) substrates obtainable from the invention might also be used in the preparation of hermetically sealed barrier pouch packages, where the package is made solely of the coated paper. In the case of the aforementioned lidding application, the coated (e.g., paper) substrates obtainable from the invention are readily recycled or composted, whereas PET-PE laminates (and other plastic laminates), especially of mixed plastic types are difficult to recycle and are most often disposed in landfill, which is undesirable.

The inventors have found that heat seals formed according to the invention have a bonding strength of at least 0.5N/25 mm, and preferably at least 1.0N/25 mm, when measured according to a T-peel test (see Examples for details).

Where the second substrate used to make a heat-sealed bonding region is a paper substrate, it may also be coated with coatings for use according to the invention (thus constituting what is known as “A-to-A heat-seals”). In the latter case, pouches, sealed bags, flow packs and the like formed from coated papers of the invention are most advantageously used to form the hermetically sealed packages.

### Coatings for Use in the Invention

### Refractive Index (RI)

The coatings for use in the invention comprise a water-soluble polysaccharide resin with a RI close to (i.e., within 10% of) that of the substrate to which it is applied. The RI is of the dry coating obtained from the water-based polysaccharide coating. Preferably, the RI of the dry coating obtained from the water-based polysaccharide coating is within 5% of that of the substrate. For example, if the substrate has an RI of 1.5, then the dry coating obtained from the water-based polysaccharide coating for use in the invention has an RI of 1.35 to 1.65 (i.e., +10% of the value of the RI of the substrate).

For example, when the substrate is a translucent (vellum) paper comprising cellulose fibres, the water-based polysaccharide coating for use in the invention has a RI closer to that of the substrate than many other biorenewable and synthetic coatings. Preferably, the RI is in the range 1.45 to 1.60 for both the coating and the substrate (e.g., paper).

Before the water-based polysaccharide coating is applied to the substrate, the method of the invention may further comprise the step of identifying the water-based polysaccharide for use in the invention by determining its RI. The step of identifying the water-based polysaccharide coating may comprise performing an analytical test in order to determine its RI (i.e., the method described in the examples). Alternatively, or in addition, the step of identifying the water-based polysaccharide coating may comprise consulting an associated technical data sheet (or equivalent information source) to determine its RI. Only those coating compositions having an RI within 10% of the substrate to which the coating is applied are used in the invention.

### Other Properties

The coatings for use in the invention preferably have low viscosity. For example, the viscosity of the coating for use in the invention is preferably 10 to 15 seconds (DIN #4) or 10 to 200 cps @ 1000/1/s shear rate, such as preferably 10 to 100, and more preferably 10 to 15 cps @ 1000 1/s shear. The inventors found that coatings having this viscosity have optimum coating penetration into paper substrates, further enhancing performance in both reducing haze and improving optical transparency.

The coatings for use in the invention preferably have a pH of 5 to 8. The solids content of the coatings for use in the invention may be 5 to 80 wt % (w/w), preferably 20 to 70 wt %, and more preferably 30 to 60 wt %. The coatings for use in the invention most preferably have a solids content of 40 to 50 wt %.

The unexpected heat-sealability of these coatings further enhances their use in (e.g., paper-based) packaging, to overcome problems with synthetic adhesives, and may also provide fully functional paper-based packaging having transparency, barrier properties, and heat-sealability. A further possible application for (e.g., paper) packaging films obtainable from the invention is in lidding applications, replacing plastic laminates, for example, lids for cooked meats.

When applied to paper packaging substrates the coatings for use in the invention provide a barrier against oxygen and grease. The coatings for use in the invention preferably also provide moisture vapor resistance to substrates.

### Components

The coating for use in the invention comprises a polysaccharide. The polysaccharide is preferably obtained from rice and/or corn, and more preferably obtained from corn The polysaccharide may be in the form of a polysaccharide composition comprising two or more different polysaccharides. The polysaccharide composition is preferably rich in maltodextrin. In other words, the polysaccharide composition for use in the invention preferably comprises at least 50 wt % of maltodextrin relative to the total amount of polysaccharide.

The coatings for use in the invention preferably comprise 30 to 60 wt % of polysaccharide solids, wherein the polysaccharide solids are derived from rice and/or corn, 1 to 8 wt % of an organic solvent, such as an alcohol, and 20 to 60 wt % water.

The coatings for use in the invention more preferably compnse 40 to 50 wt % of polysaccharide solids, such as around 48 wt % solids, wherein the polysaccharide solids are derived from corn and comprise maltodextrin, 2 to 5 wt % of alcohol, such as isopropanol, and 30 to 50 wt % water.

The maltodextrin may comprise D-Allose monomer units primarily linked by a-1,4 glucosidic bonds. The polymer chains primarily comprise 3-20 monomer units which are further crosslinked.

The weight average molecular weight (Mw) of the higher molecular weight fraction of the polysaccharide composition for use in the invention may be 50,000 to 5,000,000 Da, or 10,000 to 250,000 Da. Maltodextrins typically also comprise a significant fraction of oligosaccharides with weight average molecular weights of 300 to 5,000 Da. Without wishing to be bound by theory, the inventors postulate that the low molecular weight component of maltodextrins, such as those derived from rice and corn, helps plasticise the coatings for use in the invention, improving heat-sealability.

The glass transition temperature (Tg) of the polysaccharide for use in the invention is preferably from 100 to 200° C., or more preferably from 120 to 180° C.

Alternative polysaccharides to maltodextrins (3-20 glucose units) for use in the invention include starches (300-1,000 glucose units). The polysaccharide composition for use in the invention may also comprise intermediate, moderately high, or high amylose content (Table 1). In other words, the polysaccharide composition for use in the invention may comprise at least 16 wt % amylose relative to the total amount of polysaccharide, such as 16 wt % to 60 wt %, or 16 wt % to 40 wt %.

TABLE 1
Amylose Content

| Amylose Content (wt %) | Category |
|---|---|
| 1-9 | Very low amylose content |
| 10-15 | Low amylose content |
| 16-19 | Intermediate amylose content |
| 20-25 | Moderately high amylose content |
| 30+ | High amylose content |

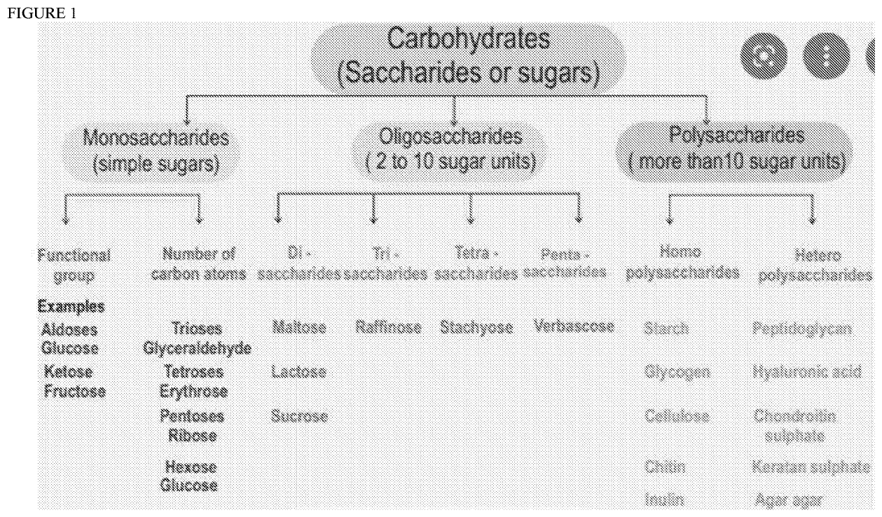

FIG. 1 defines saccharides in general and polysaccharides in particular.

### Water Solubility

The polysaccharides for use in the invention are water-dispersible. Preferably, the polysaccharides for use in the invention are water-soluble and, in the latter case, it is advantageous that the water solubility at 25° C. should be at least 5% (w/w) based on the dry weight of the polysaccharide.

### Water Content

The coating compositions for use in the invention may have a water content of 30 to 80 wt %, such as 40 to 60 wt %, or around 43 wt %, based on the total weight of the coating composition. This includes both the water present in the polysaccharide resin (e.g., Sunresin 20100) as well as any additional water added.

### Optional Additives

It is preferred that the additives incorporated into the coatings for use in the invention have a BRC of at least 50%, such as at least 70%, and more preferably at least 90%.

### Crosslinker

The coatings for use in the invention may comprise a crosslinker. Crosslinkers for use in the invention include those comprising the following reactive species; carbodiimides, oxazolines, azriridines, epoxies, amino resins (such as melamine-formaldehhydes), metal complexes (including titanate and zirconate organometallics, such as ammonium zircomum carbonate), isocyanates (including blocked isocyanates), epoxies, polyaldehydes, sodium tripropylphosphate, calcium chloride, borax and boric acid, chitin/chitosan, and combinations thereof. Preferably, the crosslinker is selected from the group consisting of sodium tripolyphosphate, calcium chloride, and combinations thereof.

The crosslinker may be incorporated into the compositions in an amount of 1 to 20 wt %, preferably in an amount of 1 to 10 wt¾, more preferably 1 to 8 wt %, even more preferably 2 to 4 wt %, and most preferably 3 to 4 wt %. The inventors have found that incorporating a crosslinker into the compositions for use in the invention can advantageously increase the hydrophobicity of the resulting coated substrates, as demonstrated by a reduction the amount of water that can be absorbed (see Table 5).

### Additional Resins

The coatings for use in the invention may also include an additional water-soluble, alkali-soluble, and/or water-dispersible resin, in addition to the polysaccharide.

The additional resms include both resins derived from renewable sources and resins derived from petrochemicals and include; polyurethane dispersions, self-crosslinking polyurethane dispersions, alkali-soluble acrylics, acrylic dispersions, self-crosslinking acrylic dispersions, polyester dispersions, poly(vinyl acetate) and copolymers of vinyl acetate dispersions, poly(vinyl alcohols), poly(vinyl pyrrolidones), rosin ester resms, among others, and combiations thereof.

Other resins and materials could be used in the coatings for use in the invention, and especially preferred are alternative resins and materials having high BRC (e.g., at least 70%, preferably 100% BRC) and that do not cause the coating to fail key properties (for example, dehazing, heat-sealability, etc.).

### Water-Soluble Organic Co-Solvent

The coatings for use in the invention may comprise a water-soluble organic co-solvent. Volatile solvents such as ethanol, propanol, and isopropanol may be used. Glycol ether solvents can also be incorporated, including polyols, an alkylene glycol, an alkylene glycol ether or ether acetate type.

Non-limiting examples include: 4-hydroxy-4-methyl-2-pentanone, diethyelene glycol, diethylene glycol butyl ether, diethylene glycol ethyl ether, diethylene glycol methyl ether, diethylene glycol monoethyl ether acetate, diethylene glycol monopropyl ether, dipropylene glycol, dipropylene glycol ethyl ether, dipropylene glycol methyl ether, ethylene glycol butyl ether, ethylene glycol ethyl ether, ethylene glycol isopropyl ether, ethylene glycol methyl ether, ethylene glycol propyl ether, glycerine carbonate, N-methyl 2-pyrrolidone, glycerol, propylene glycol, propylene glycol ethyl ether, propylene glycol ethyl ether acetate, propylene glycol methyl ether, propylene glycol n-propyl ether, triethylene glycol, triethylene glycol butyl ether, triethylene glycol methyl ether, tripropylene glycol, tripropylene glycol methyl ether, N-methyl pyrollidone, urea, combinations thereof, and the like.

It is preferred that at least 0.5 wt % of organic cosolvent is incorporated into the coatings for use in the invention, more preferably at least 1 wt %, such as between 1 and 10 wt¾, and even more preferably at least 2 wt % of organic cosolvent is incorporated into the coatings for use in the invention, such as 2 to 8 wt %. The organic cosolvent for use in the invention is preferably an alcohol, such as ethanol, propanol, and isopropanol, more preferably the organic cosolvent for use in the invention is isopropanol. The coatings for use in the invention preferably comprise 1 to 10 wt %, such as 1 to 8 wt % or 2 to 5 wt %, or around 2 wt %, of isopropanol.

Without wishing to be bound by theory, the inventors postulate that the presence of the organic co-solvent (e.g., an alcohol) further increases penetration of the coating into the substrate, and in particular paper substrates, which results in further increases in transparency and further decreases in haze. The increased penetration of coating compositions comprising an organic co-solvent is postulated to result from improved wetting. This is observed from a comparison of the surface tension of the coating compositions, wherein increasing the amount of organic co-solvent (e.g., alcohol) decreases the surface tension, as described in the examples.

It is preferred that if co-solvents are incorporated, they form less than 40% (w/w) of the coating composition, preferably less than 30% (w/w), more preferably less than 20% (w/w), and most preferably less than 10% (w/w) of the coating composition.

Biocide and/or Anti-Mould

The coatings for use in the present invention are water-based. Thus, it is preferable to include a biocide and/or anti-mold agent. Suitable examples include products based on the following biocide structural types: benz-isothiazolinone, bromo-nitro-propane-diol, isothiazolinone, ethylenedioxydimethanol, iodo-propynyl butyl carbamate, and combinations thereof.

Commercially available grades include those marketed under the trade names Intercide (Akcros Chemicals) or Nipacide (Clariant). Other biocides that could be used include sodium dehydroacetate (Geogard 11IS from Lonza), sodium benzoate (Vancide 51 from R. T. VANDERBILT), sodium pyridinethiol-I-oxide (Sodium Omadine from Arch Chemicals), sodium salt of o-phenylphenol (Dowicide A from DOW Chemical) and ethyl p-hydroxybenzoate (Nipastat Sodium from Aako).

A biocide and/or anti-mold agent is/are preferably incorporated into the coatings for use in the invention in an amount of 0.01 to 1.00% by mass in the coating (e.g., ink) composition.

### Defoamers

Defoamers are optionally included in the coatings for use in the invention. Defoamers prevent the formation of foam during manufacture of the coatings/ink, and also while jetting. Defoamers are particularly important with recirculating printheads.

Examples of suitable defoamers include, but are not limited to, TEGO FOAMEX N, FOAMEX 1488, 1495, 3062, 7447, 800, 8030, 805, 8050, 810, 815N, 822,825,830,831, 835, 840, 842, 843, 845, 855, 860, and 883, TEGO FOAMEX K3, TEGO FOAMEX K7/K8 and TEGO TWIN 4000 available from Evonik. Available from BYK are BYK-066N, 088, 055, 057, 1790, 020, BYK-A 530, 067A, and BYK 354. The additives DC62, DC65, DC 68, DC71 and DC74 are available from Dow Corning. Agitan 120, 150, 160, 271,290,298,299,350,351, 731, 760, 761, and 777 are available from Munzing. Surfynol 104PA, AD0I, DF-110, DF-58, DF-62, DF-66, DF-695, DF-70, and MD-20 are available from Air Products.

### Surface Control Additives

The coatings for use in the invention may comprise a surface control additive. Surface control additives are often added to inks to control the surface tension, which is required to adjust the wetting on the face plate of the printhead, and also to give the desired wetting on the substrates onto which the inks are printed. Surface control additives can also be used to control the level of slip and scratch resistance of the coatings for use in the invention.

Surface control additives for use in the invention include polyacrylates, polyether siloxane copolymers, siloxane-based gemini surfactants, silicones, wax dispersions, and combinations thereof.

Examples of suitable surface control additives include, but are not limited to, TEGO FLOW 300,370, and 425, TEGO GLIDE 100, 110,130,406,410,411,415,420,432,435,440, 482, A1 15, and B1484, TEGO GLIDEZG400, TEGO TWIN 4000 and 4100, TEGO WET 240, 250, 260, 265, 270, 280, 500, 505, and 510 and TEGO WET KL245, all available from Evonik. Available from BYK are BYK 333 and 337, BYK 378, 347 and 361, CERAFLOUR 998 and 996, NANOBYK 3601, 3610, and 3650, and CERMAT 258. Surfynol 104, 420, 440, 465, 485, 61, 82, and 2502 are available from Air Products. Multiwet BD, EF, SU, SO, and VE are available from Croda. Capstone FS-30, 31, 34, 35, 50, 51, 60, 61, 63, 64, 65, and 3100 are available from Du Pont.

### Colorant

The invention is primarily directed towards clear coating compositions. However, the coating compositions for use in the invention may further comprise a colourant to bring further embellishment to the substrate, such as packaging paper.

Colourants include those species derived from petrochemical. Preferably, the colorant for use in the invention is derived from renewable and/or bio-sources.

The coatings for use in the invention may comprise one or more colorants, including pigments and/or dyes. Examples of suitable organic or inorganic pigments for use in the invention include carbon black, zinc oxide, titanium dioxide, phthalocyanine, anthraquinones, perylenes, carbazoles, monoazo and disazobenzimidazoles, rhodamines, indigoids, quinacridones, diazopyranthrones, dinitroanilines, pyrazoles, diazopyranthrones, pyrazoles, dianisidines, pyranthrones, tetracholoroisoindolines, dioxazines, monoazoacrylides anthrapyrimidines, and combinations therefore. Examples of dyes for use in the invention include, but are not limited to, azo dyes, anthraquinone dyes, xanthene dyes, azine dyes, and combinations thereof. Also encompassed by the invention are dyes derived from foodstuffs.

### Nanoclays

The coatings for use in the invention provide an oxygen barrier to substrates, such as paper packaging substrates. To enhance this property further, the coatings may optionally further comprise nanoclays that improve the oxygen barrier performance by increasing the ‘tortuosity’ of the coating to the diffusion of oxygen (as well as and moisture vapour and any other gases, including nitrogen and carbon dioxide).

Nanoclays that may be included in the coatings for use in the invention include, but are not limited to, natural nanolcays, such as bentonites, hectorites, kaolins and vermicullites, or synthetic nanoclays, such as laponites. Incorporating nanolcays into the coatings for use in the invention therefore provides improved barrier performance. For example, coatings for use in the invention may have an oxygen transmission rate (OTR) at 25° C. and 50% relative humidity (RM) of less than 100 cm³ m⁻² day⁻¹ for a 1 μm dry layer of the coating.

The coatings for use in the invention preferably also enhance the moisture vapour barrier performance of substrates, such as paper packaging. The coatings for use in the invention can provide coated substrates with a moisture vapour barrier performance at 25° C. and 50% RM of less than 100 g m⁻² day⁻¹ for a 1 μm dry layer of the coating.

Nanoclays can be incorporated into the compositions for use in the invention to further improve the barrier properties. When incorporated, nanoclays are used in an amount of 0.1 to 20 wt %, preferably 1 to 10 wt %, relative to the total coating composition.

### Plasticisers

The coatings for use in the invention may also comprise a plasticiser. Plasticisers may enhance the heat-sealability of the coatings but may also enhance the moisture vapour barrier performance. Without wishing to be bound by theory, the inventors postulate that plasticisers aid the flexibility of the coatings for use in the invention after the coating is evaporatively dried and can also help to make heat-sealing more effective by ensuring that the polysaccharide-based coating is sufficiently thermoplastic.

Where substrates (e.g., papers) obtainable from the invention are used in heat-sealable applications, it is preferred that the bond strength of the heat-sealed junction is at least 0.5N/25 mm, and more preferably at least 1.0N/25 mm in a T-peel test, as known by the skilled person and described in the examples. The heat-seals formed by substrates coated with coatings for use in the invention include both plastic and paper substrates.

The plasticisers may be selected from any of the following non-limiting examples; glycerol, propylene glycol, triethylene glycol, poly(ethylene glycol), sorbitol, xylitol (and other sugars), urea, and combinations thereof.

WO2021/019468, U.S. Pat. No. 7,427,643B2, U.S. Pat. No. 8,557,033B2, U.S. Pat. No. 10,934,448B2, U.S. Pat. No. 9,878,839B2, U.S. Pat. No. 6,066,368B2, and U.S. Pat. No. 8,734,959B2 are herein incorporated by reference in their entirety and disclose plasticisers, hydrophobizing agents, and clays that can be incorporated into the coatings for use in the present invention.

### Waxes

The coatings for use in the invention may comprise any blend of wax emulsions or dispersions. To maintain high BRC of the coatings, waxes derived from natural sources such as carnauba, beeswax, candelilla, rice bran wax, vegetable oil derived waxes are preferred. However, waxes derived from petrochemical sources may also be used and include paraffin, polyethylene, polypropylene, polyamide, and montan waxes.

It is preferred that each of the above additives is derived from renewable and sustainable sources. For example, in terms of wetting aids and surfactants those derived from bio-based ethoxylated natural fatty alcohols and sorbitan esters may be used. Suitable wetting aids include oligosaccharide, glucitol, polyhydroxy amide, sufosuccinate, and combinations thereof.

### Biorenewable Content (BRC)

The coatings for use in the present invention preferably have at least a 90% BioRenewable Content (BRC), more preferably at least 95%, and even more preferably 100% BRC. The solids content of the coating for use in the invention preferably comprises at least 80%, such as at least 90%, of materials derived from sustainable or biorenewable sources, i.e., the solids preferably have a BRC of at least 80%, such as at least 90%. The BRC content of the inventive coatings was tested by an independent lab and found to be 100% Biogenic Carbon Content (as a fraction of total carbon). Wherein Biogenic carbon refers to carbon from “renewable” (biomass or animal by-product) sources versus petroleum (or otherwise fossil) sources.

The coatings for use in the present invention are preferably based on the 100% BRC Sunresin 20100, which is a water-soluble polysaccharide resin derived from corn and is blended with water. The resin is preferably non-chemically modified.

### Substrates

The substrates for use in the invention are transparent or translucent paper or plastic substrates. By transparent substrate it is meant that the total visible light transmittance of the substrate is at least 80%.

The uncoated substrates for use in the invention may have a total visible light transmittance of at least 70%, such as at least 80%, or at least 90%. The uncoated substrates for use in the invention may have a haze of up to 100%.

Substrates for use in the invention include paper, preferably translucent vellum paper.

The paper substrates for use in the invention (i.e., pre-coated) may have a paper weight of 10 to 400 g/m² (gsm), preferably 20 to 200 g/m², more preferably 30 to 150 g/m², and even more preferably 30 to 70 g/m².

The substrates for use in the invention may have a thickness of 1 to 200 μm, preferably of 10 to 150 μm, such as 10 to 100 μm, more preferably 20 to 80 μm, and even more preferably 30 to 55 μm. Thickness is measured using a micrometer in accordance with ASTM F2251-13 (2018).

The substrates for use in the invention preferably comprise less than 20 wt % cellophane relative to the total weight of the substrate, more preferably less than 10 wt % cellophane, and even more preferably are substantially free of cellophane.

The substrates for use in the invention preferably have a BRC of least 50 wt %, such as at least 60 wt %.

The substrates for use in the invention may have a Bendsten roughness of 0 to 1000 ml/min, preferably from 30 to 800 ml/min, more preferably from 100 to 700 ml/min, and even more

preferably from 140 to 600 ml/min. The Bendsten roughness of the sides of the substrates for use in the invention may vary. Accordingly, one side of the substrate for use in the invention may be rougher than the other. In particular, one side of the substrate for use in the invention may have a Bendsten roughness of between 30 and 1000 ml/min, preferably 100 to 700 ml/min and more preferably 250 to 600 ml/min. The other side of the substrate for use in the invention may have a Bendsten roughness of 0 to 400 ml/min, preferably 20 to 300 ml/min, and more preferably 100 to 200 ml/min.

The substrates for use in the invention may have a density of 0.6 to 2 g/cm³, preferably 0.7 to 1.5 g/cm³, more preferably 0.9 to 1.4 g/cm³, and even more preferably 1.0 to 1.25 g/cm³. The substrates for use in the invention may have a density of 1.0 to 1.1 g/cm³.

Without wishing to be bound by theory, the inventors postulate that the surface roughness and density of the substrate can affect the degree of penetration into the substrate by the coating, and thus the amount of transparency increase and haze decrease achieved by the invention.

### Packaging

The methods and use of the invention can also provide hermetically sealed packages, such as pouches, sealed bags, flow packs and the like.

### Test Methods

### L. (Glass Transition Temperature):

The glass transition temperature can be determined using differential scanning calorimetry (DSC) according to the process defined in ASTM E1 356-08. The sample was maintained under an atmosphere of dry nitrogen for the duration of the scan. A flow rate of 20 ml/min and Al pans were used. Samples (5 mg) were heated at 20° C./min from 20° C. to 350° C. The value of a T_{g} was determined as the extrapolated onset temperature of the glass transition observed on the DSC scans (heat flow (W/g) against temperature (° C.)), as described in ASTM E1356-08.

### Viscosity

Viscosity is measured at 32° C. using a TA Instruments AR1500ex Rheometer at a shear rate of 1000 1/s.

### Biorenewable Content (BRC)

The BRC is calculated by taking the percentage of renewable feedstock of each raw material used. Thus, the percentage of bio-renewable content of a material=molecular weight of the natural fragment divided by the total molecular weight, times 100.

The carbon-14 method is used to calculate the BRC of both the individual components and final composition. The carbon-14 method accurately measures the content of carbon from renewable sources, such as plants. This test is performed according to international standard ASTM D6866. By measuring the carbon-14 content, ASTM D6866 is able to distinguish between contemporaly carbon sources like biomass (biobased carbon) and carbon from petroleum derivatives. Biomass has a known content of carbon-14, whereas petroleum-derived materials do not contain any. For the coatings of the invention, carbon-14 measurements were determined using ASTM D6866-18 Method B (AMS).

### Molecular Weight

### Molecular Weight of Non-Polymeric or Oligomeric Compounds

The molecular weight of non-polymeric or oligomeric compounds is defined and calculated by the molecular structure of the compound. Usually, this is given by the supplier technical data sheet of the compound or can be found on the webpage of the European Chemical Agency (ECHA).

### Molecular Weight of Polymeric and Oligomeric Compounds-GPC

This was determined by size exclusion chromatography, specifically gel permeation chromatography (GPC), with a monodisperse polystyrene equivalent molecular weight calibration standard and GPC columns (manufactured by PSS (Polymer Standards Service-USA, Inc), applied column combination: SDV 5 μm 1000 A, SDV 5 μm 500A, SDV 5 μm 100 A). The flow rate in the columns is 1.0 ml/min, eluent: tetrahydrofuran, column temperature: 40° C., a differential refractive index detector (RI) and a UV-detector (254 nm) were used. The dispersibility DISP=(Mw/Mn) is the quotient of molecular weight average and number average and was calculated from the measurement results. Unless otherwise stated, the molecular weight of polymeric and oligomeric compounds is the number average molecular weight.

### Compostability

Refers to the ability of materials to biodegrade naturally within a specified timeframe under controlled conditions. Compostable materials comply with ASTM D6400, point 6.2 and/or ASTM D6868, point 6.2.

### Biodegradability

Refers to the conversion of organic carbon present in a sample into carbon dioxide under controlled condition, in accordance with ASTM D6400 and/or ASTM D6868, point 6.3. Where the biodegradability is defined in terms of a percentage, it is the percentage of the material that remains following the tests outlined in one of the above-mentioned standards.

### Oxygen Rate Transmission (OTR)

OTR was tested according to ASTM D3985 on a Systech Oxysense 8101 Analyzer and results are recorded in cc/m²/day. In this case, tests were carried at 25° C. and 50% relative humidity. To reduce the effect of oxygen ingress at the edges of the paper, a foil mask with a 5 cm aperture was also used.

### Refractive Index Testing

The refractive index of the final coating, pure polysaccharide resin and other biorenewable/synthetic resin options were measured in their dry form using a RFM 900-T refractometer (589.63 nm-ASTM D2140). To achieve an accurate reading and sufficient contact with the glass prism, the coating/resin options were added to the machine in their wet form and left to dry in situ. To do this, the temperature of the apparatus was set to 50° C. until all water content was removed, then reduced back down to 20° C. for the measurement.

### Haze and Transmission Testing (i.e., Transparency)

Transparency of the coated papers was quantified using a Byk Gardner Haze Guard Dual to measure visible light transmission in accordance with ISO 13468 1:2019 (E). Haze was also measured using the Byk Gardner Haze Guard Dual, in accordance with ISO 14782:2021. For completeness, while ISO 14782:2021 is stated to be applicable to haze values of less than 40%, it can also be used to evaluate haze values of 40% and above, albeit with decreased accuracy. To mitigate for this decrease in accuracy, at least 4 measurements were taken of each sample, and an average taken.

Samples were prepared by coating 2 layers to each side of the paper using a k-bar (ex. RK Print), with a 4-to-6-micron wet coat weight applied per layer. Each layer is force dried at a temperature of 60 to 80° C. for 10 to 20 seconds. Uncoated and coated papers were all held against the com-port and haze-port accordingly to retrieve a haze and transmission value as a percentage.

### Heat-Seal Testing:

Paper samples were prepared in the same manner as described above for the haze and transmission testing. Furthermore, a >100 g/m² Kraft paper was also used as a representative for the main body of packaging in a complete engineered product. The Kraft board was coated using a single application at 6 μm to deposit roughly 3 to 6 g/m² dry. The coated translucent paper was then sealed against itself, against virgin Kraft paper and a Kraft paper coated with the single layer of coating to evaluate heat-sealing capability in various packaging scenarios.

Testing was carried out on a C632B hot tack tester (ex. Labthink) using ASTM F1921-1921M-12 method. Parameters used were 25 mm sample width, 40 psi pressure, 0.2 sec. jaw clamping time and 1500 mm/min speed. Various temperatures were assessed to create heat-seal curves, where a 0.5 sec. dwell time (sample cooling) was used to replicate hot tack conditions and 180 seconds for standard heat-seal. The results are reported as N per 25 mm sample width.

### Grease Resistance Testing

Samples were double side coated as described in the above “Haze and Transmission Testing” section, and 10×20 cm sample pieces were prepared. An area of the sample was then folded 180° using a folding tool and placed back into flat position. The sample is then taped flat onto a non-porous, uncontaminated surface and all edges taped off to protect from any unwanted penetration caused by oil spreading. 2-3 drops of olive oil are then applied in a line onto flat and folded areas of the substrate. Each drop of oil is classed as a duplicate test. The sample is then assessed observationally for areas of penetration over selected periods of time (24, 72 & 168 hr.).

A second grease test was performed known as a “kit test” according to TAPPI T559. This method describes a procedure for testing the degree of repellency and/or the anti-wicking characteristics of paper or paperboard treated with fluorochemical sizing agents. Testing involves placing a series of numbered reagents (varying in surface tension and viscosity or “aggressiveness”) onto the surface of the samples. The solutions are numbered from 1 (the least aggressive) to 12 (the most aggressive). The highest numbered solution that does not stain the surface is reported as the “kit rating”.

### Sur/ace Roughness

The surface roughness of the substrates was measured using a Bendsten Tester according to ISO 8791-2.

### Surface Energy

The surface energy of the (coated) substrates was measured according to ASTM D7490-13 (2022).

Dynamic surface tension of the coating compositions was measured using a SITA bubble pressure tensiometer at 25° C. and 2.7 Hz and static surface temperature was measured using a SITA bubble pressure tensiometer at 25° C. and a bubble frequency of 0.025 Hz.

### Cobb Test for Cross/Inking Study:

The wet samples were coated using the above “Haze and Transmission Testing” section and tested for water uptake using Tappi T441 method. The cobb ring used in this instance was 25 cm². The improved Cobb values shown in Table 5 indicate the advantage of using a crosslinker.

### Overprinting Method:

To show suitability for overprintability, translucent paper was coated and dried with the Example 1 coating (as per above “Haze and Transmission Testing” section) and subsequently overprinted with a DFC cyan based ink (Aquasafe DFC Reflex Blue GAQS-50002, Sun Chemical) using a #350 (6 cc anilox). The ink was force dried at 40 to 60° C. for 10 to 20 seconds The ink showed no signs of reticulation, which is indicative of good overprinting and laydown characteristics.

To further exhibit overprintability, a measurement was taken of the surface energy of the coated surface of Example 1 with de-ionised water as the media, which gave a value of 56.7 mJ/m². In terms of what this means from a scientific/technical point of view, a surface energy (SE) of ::S 35 mJ/m² would be very difficult to overprint and would often require corona treatment. A SE of 35-40 J/m² is printable, but >40 J/m² is more desirable in terms of overprintability features. This is more relevant to water-based systems/inks due to the naturally higher surface tension of the liquid being applied onto the surface.

### EXAMPLES

### Substrates for Use in the Examples

| | | Bendsten Roughness (ml/min) | | |
|---|---|---|---|---|
| | Thickness | Rou2h | Smooth | Density |
| Substrate | (μm) | side | side | (g/cm³)* |
| Sylvicta 42gsm | 40 | 518 | 143 | 1.05 |
| Sylvicta 62gsm | 51 | 251 | 146 | 1.21 |
| SP Cristal 35gsm | 25 | 39 | 0 | 1.40 |
| SP Cristal 40gsm | 30 | 169 | 0 | 1.33 |

*The density was calculated from the following equation: Density (d) = mass (m)/volume (v).

### Preparation and Testing of Coating Examples

### Example 1

Example 1 was prepared by combining 50% (w/w) of a water-soluble polysaccharide resin (Sunresin 20100 derived from corn) with 50% water and mixed on a low shear stirrer for approximately 15 min. The product is left for a minimum of 30 min. before coating to enable any trapped air to dissipate. The other coating examples are as shown in Table 3. Sunresin 20100 has a water content of 30 to 50 wt %, such as around 40 wt %.

The resulting low viscosity coatings were applied using the protocol described in the above Haze and Transmission Testing section.

The penetration of the first layer is important for enhanced transparency. The water acts as the carrier and helps to reduce the coating viscosity sufficiently for penetrating through the pores of the paper. The resin is then deposited into the air cavities within the paper and remains in situ as the water particles drive off upon drying. The purpose of any second or further coating application is to fill pores further and provide a smooth surface. Wetting aids can be added to the coatings in order to enhance penetration of the coating into the pores of the paper.

The grease resistance of inventive example 1 was determined.

TABLE 2
Olive oil & Kit Grease Resistance Results for Inventive Example I

| | Control | Inv. Ex. 1 |
|---|---|---|
| | Uncoated Sylvicta | Coated substrate |
| | 42 g/m² | 2 hits per side |
| KIT rating | 0 | 12 |

Grease Resistance (Olive Oil)

| | | |
|---|---|---|
| 24 hr. | fail | pass |
| 72 hr. | fail | pass |
| 168 hr. | fail | pass |

Where pass indicates no visible penetration of the olive oil through the coating and into the substrate; and fail indicates visible penetration of the olive oil through the coating and into the substrate.

Table 2 clearly shows the excellent grease resistance properties imparted by the coatings of the present invention.

TABLE 3
Inventive Example I and Comparative Examples 2 to 4: % Haze,
% Transmission (% Trans), and Dry Refractive Index (RI)

| | Description of | | Change in | | Change in | |
|---|---|---|---|---|---|---|
| Example | coating | % Haze | % Haze | % Trans | % Trans | RI² |
| None | Uncoated substrate | 93.9 | n/a | 81.7 | n/a | 1.45-1.6 |
| Inventive Ex. 1: Sunresin | ¹100% BRC | 65.1 | −28.8 | 85.1 | +3.4 | 1.5164 |
| 20100 (100% BRC com | Polysaccharide | | | | | |
| starch diluted 50/50 in | | | | | | |
| water) | | | | | | |
| Comp. Ex. 2: Joncryl 1700 | Acrylic Dispersion | 66.8 | −27.1 | 84.8 | +3.1 | 1.4990 |
| Comp. Ex. 3: Joncryl | Acrylic Dispersion/ | 68.8 | −25.1 | 84.0 | +2.3 | 1.5017 |
| 1700:Joncryl 8078 (90:10) | solution blend | | | | | |
| Comp. Ex. 4: WNA 392 | Fumaric resin | 76.8 | −17.1 | 82.6 | +0.9 | 1.4458 |
| (Erkamar 3275) | dispersion | | | | | |

¹0nly the Sunresin 20100 is 100% BRC among the coatings in Table 3.
²The RI of the coatings of Inventive Example 1 and Comparative Examples 2 to 4 correspond to the coatings only (i.e., without the substrate). The RI of the uncoated substrate is taken from a measurement of nanocellulose. Paper substrates, such as translucent and vellum papers comprise nanocellulose, such that the RI measurement for nanocellulose can be used as a reference for such substrates.

As can be seen in Table 3, the coating (Comp. Ex. 4) that falls outside of the RI range of 1.45 to 1.60 (i.e., within 10% of the RI of the substrate having an RI of 1.525 (1.45 to 1.6) does not provide the same degree of % haze reduction and % transmission increase as those within the 1.45 to 1.60 RI range. The coatings used in comparative examples 2 and 3 have R is within 10% of the RI of the substrate. However, these coating compositions are made of acrylic dispersions and thus are not water-based polysaccharide coatings and do not have the advantageous properties, e.g., high BRC.

To further exhibit the performance of the Example 1 inventive composition, coatings were applied using the protocol described in the above “Haze and Transmission Testing” section. The papers used were ‘Sylvicta’, ex. Arjowiggins and SP Cristal, ex. Ahlstrom-Munksjo.

TABLE 4
Performance of the Example I Inventive Composition
on various Translucent Packaging Papers

| | Wet coat | % HAZE | | | % TRANSMISSION | | |
|---|---|---|---|---|---|---|---|
| | weight | | | % | | | % |
| Substrate | applied | uncoated | coated | Change | uncoated | coated | Change |
| Sylvicta | 2 × 4- | 97.6 | 61.2 | −36.4 | 92.5 | 95.0 | +2.5 |
| 42 g/m² | 6 g/m²/side | | | | | | |
| Sylvicta | 2 × 4- | 97.5 | 66.7 | −30.8 | 91.6 | 94.6 | +3 |
| 62 g/m² | 6 g/m²/side | | | | | | |
| SP Cristal | 1 × 4- | 63.0 | 44.1 | −18.9 | 86.0 | 86.9 | +0.9 |
| 35 g | 6 g/m²/side | | | | | | |
| SP Cristal | 2 × 4- | 81.8 | 64.9 | −16.9 | 79.3 | 81.8 | +2.5 |
| 40 g | 6 g/m²/side | | | | | | |

The results in Table 4 confirm that a coating prepared according to the invention can enhance the transmission and reduce the haze of translucent papers useful in the food packaging industry.

As would be appreciated by the skilled person, the size of the transparency increase and/or size of haze decrease will also depend on the identity of the substrate. For example, variation in substrate roughness and density can affect the penetration of the coating into the substrate. Thus, substrates that have a low density and a high degree of roughness may facilitate increased coating penetration than fir substrates that have a higher density a lower roughness. Thus, a larger increase in transparency/decrease in haze may be achieved for substrates of lower density and increased roughness.

Moreover, analysis of the Sylvicta substrates of 42 g/m², confirmed that the OTR is improved by applying the coatings for use in the present invention:
Uncoated substrate=112 cc/m²/day
Substrate coated with Example coating=18.9 cc/m²/day.
The OTR could thus be further improved through the addition of nanoclays.

### Heat-Sealing Performance of the Coatings for Use in the Invention

Following the procedures laid out previously the heat-sealing capacity of papers coated with the inventive composition were assessed. Heat-sealability was evident in a variety of scenarios. These included coated paper to coated paper, coated paper to virgin (Kraft) paper. Sealing capability is detected as low as 60° C., and the optimum sealing window lies within 100 to 150° C. range. The ability to seal in this manner provides opportunity for a variety of packaging designs; including lidding, pouch, flow packs, sealed bags and laminates. In the case of laminates that includes paper to paper laminates and paper to plastic film laminates. Another tremendous advantage of the current technology is the relatively low optimum sealing temperature of 100-150° C.

In Table 5 heat-sealability is exhibited by fiber tear ratings, where prints were prepared by applying 2 layers of the Example 1 coating on each side of Ahlstrom 40 g/m² Cristal paper and dried for 10 sec. at 100° C. Total dry coat weight is 10 g/m². Instrument is a Specac blocking tester with clamp test parameters of 0.2s clamp, 275 kPa pressure. A rating of 3 or higher is considered a pass, with 5 being considered ideal. These examples also exhibited acceptable bond strength.

TABLE 5
Fiber Tear Ratings for Coated Paper - Coated Paper

| Temperature (° C.) | 180 sec. dwell |
|---|---|
| 60 | 3 |
| 80 | 5 |
| 100 | 5 |
| 120 | 5 |
| 140 | 5 |

### Use of Cross/inkers to Enhance the Resistance Properties of the Coating

Crosslinking chemistry can be used to enhance the aesthetic and water resistance properties of the final dried system. Salts such as sodium tripolyphosphate (STPP) and calcium chloride have been studied as a method of crosslinking ionically to achieve further improvement within these performance areas. Evidence shows a level of 3-4 wt % of STPP can improve hydrophobicity by up to 15% for the coating and 30% in comparison to the uncoated substrate. Though STPP was used as the crosslinking agent in the Table 4 examples, other crosslinkers well known in the art could also be used, for example calcium chloride, boric acid, etc. Table 5 displays data indicating how introduction of STPP in 2 to 4 wt % included crosslinking, which reduce the amount of water that could be absorbed into the coated substrates.

TABLE 6
Cobb Test Results with STPP as a Crosslinker

| Sample | 5 minute cobb (g/m²) |
|---|---|
| Uncoated substrate | 24.00 |
| Ex. 1 coating | 19.70 |
| Ex. 1 Coating with 2 wt % STPP | 18.40 |
| Ex. 1 Coating with 3 wt % STPP | 16.70 |
| Ex. 1 Coating with 4 wt % STPP | 17.50 |

### Measuring the Surface Tension of Coatings for Use in the Invention

Compositions were formulated as indicated in Table 6 and the surface tension measured using a SITA bubble pressure tensiometer. The compositions were also applied to substrates (Sylvicta 42 gsm) and the transmission and haze was measured.

TABLE 7
Surface Tension, Transmission, and Haze Testing of Coating
Compositions Comprising Increasing Amounts of IPA

| | Water | | | |
|---|---|---|---|---|
| | (control) | Composition | Composition | Composition |
| Component | (wt %) | one (wt %) | two (wt %) | three (wt %) |
| Sunresin 20 I00 | 0 | 50 | 50 | 50 |
| 85:15 water:IPA | 0 | 0 | 6.5 | 13 |
| mixture | | | | |
| Water | 100 | 50 | 43.5 | 37 |
| TOTAL | 100 | 100 | 100 | 100 |
| Wt % water¹ | 100 | 70 | 69.0 | 68.1 |
| Wt3/4IPA | 0 | 0 | 1.0 | 2.0 |
| Surface Tension | 72.9 | 65.7 | 54.4 | 50.8 |
| (mN/m)2 | | | | |
| Transmission(%) | n/a | 84.5 | 84.5 | 84.5 |
| Haze(%) | n/s | 67.3 | 66 | 65.9 |

¹Calculated based on Sunresin 20100 with a 40 wt % water content.
2Calculated using the bubble pressure tensiometer method.

As can be observed in Table 6, as the amount of IPA in the coating compositions was increased, the surface tension of the coating compositions reduced. Consequently, the coating compositions comprising IPA (i.e., Compositions two and three) afforded coated substrates with reduced haze relative to coating compositions not comprising IPA (i.e., Composition one). The inventors postulate that having a reduced surface tension allows the coating compositions to penetrate substrates more easily, resulting in an increased reduction in haze.

### Numbered Paragraphs of the Invention Forming Part of the Description

The invention is further described by the following numbered paragraphs:

1. A method of increasing the transparency of a substrate, comprising;
applying a water-based polysaccharide coating to a transparent or translucent paper or plastic substrate, wherein the refractive index of the dry coating is within 10% of the substrate.

2. The method of paragraph 1, wherein the refractive index of the dry coating is within 5% of the substrate.

3. The method of paragraph 1 or 2, wherein the refractive index of both the dry coating and the substrate is 1.45-1.60.

4. The method of paragraph 1 or 2, wherein the substrate is a translucent vellum paper.

5. The method of any preceding paragraph, wherein the polysaccharide is a maltodextrin derived from corn or rice.

6. The method of any preceding paragraph, wherein the polysaccharide has a water solubility at 25° C., of2::5% (w/w) based on the dry weight of the polysaccharide.

7. The method of any preceding paragraph, wherein the coating is based on 2::80% BRC materials, or 2::90% BRC materials, 2::95% BRC materials or 2::98% BRC materials, or 100% BRC materials.

8. The method of any preceding paragraph, wherein the coating is compostable.

9. The method of any preceding paragraph, wherein the coating is recyclable.

10. The method of any preceding paragraph, wherein the coating is suitable for direct food contact applications.

11. The method of any preceding paragraph, wherein the coating has a print viscosity of Low viscosity, for examples in the range of 5-15 seconds (DIN #4) or 5-20 cps @ 1000 1/s shear.

12. The method of any preceding paragraph, wherein the coating 1s heat-sealable, at temperatures between 80-200° C.

13. The method of any preceding paragraph, wherein the coating provides a barrier to oxygen, at 25° C. and 50% relative humidity, of::S than 100 cm³/m²/24 hours per μm.

14. The method of any preceding paragraph, further comprising one or more wetting additives.

15. The method of any preceding paragraph, further comprising a crosslinker.

16. The method of any preceding paragraph, wherein the coating is applied by a method selected from the group consisting of flexography, gravure, offset, spray, inkjet and roller coating.

17. The method of any preceding paragraph, wherein the coating has a solids content between 5-80% ((w/w), or 10-70%, or 15-60%.

18. The method of any preceding paragraph, wherein the glass transition temperature of the polysaccharide is 100-200° C., or 120-180° C.

19. A printed article comprising one or more layers of the coating of paragraphs 1-18 on a substrate.

20. The article of paragraph 19, wherein the substrate is a transparent or translucent paper or plastic substrate.

21. The article of paragraph 19 or 20, wherein the haze value is less than 70%.

22. The article of any one or more of paragraphs 19-21, wherein the optical transmission is 2::80%, or 2::85%, or 2:90%.

23. The article of any one or more of paragraphs 19-22, wherein the article is a food packaging article.

The present invention has been described in detail, including various embodiments thereof. However, it will be appreciated that those skilled in the art, upon consideration of the present disclosure, may make modifications and/or improvements on this invention that fall within the scope and spirit of the invention.

1-46. (canceled)

47. A method of increasing the transparency of a substrate, comprising:
a) applying a water-based polysaccharide coating to a transparent or translucent paper or plastic substrate to form a coated substrate, wherein the coating comprises 30 to 60 wt % of polysaccharide solids, wherein the polysaccharides are derived from rice and/or corn, 1 to 10 wt % of an organic solvent, and 20 to 60 wt % water;
wherein the refractive index of the dry coating is within 10% of the substrate; wherein refractive index is measured according to the method described in the description; and
wherein the coating is applied by a method selected from flexographic printing or gravure printing.

48. The method of claim 47, wherein the water-based polysaccharide coating is heat-sealable, to itself or to a second substrate, by the application of heat and pressure in a heat-sealing process which comprises:
i) forming a bonding region by contacting the coated substrate with either itself or with the second substrate; and
ii) applying heat and pressure to the bonding region to form a seal.

49. A method of heat-sealing a transparent or translucent paper or plastic substrate, comprising the steps of:
a) applying a water-based polysaccharide coating to the substrate to form a coated, heat-sealable substrate, wherein the coating is as defined in step a) of claim 47; wherein the refractive index of the dry coating of the water-based polysaccharide is within 10% of the refractive index of the substrate; wherein refractive index is measured according to the method described in the description; wherein the coating is applied by a method selected from flexographic printing or gravure printing;
b) forming a bonding region by contacting the coated substrate with itself or a second substrate;
c) applying heat and pressure to the bonding region to form a seal, wherein the heating temperature is from 60° C. to 200° C.

50. The method of claim 49, wherein the heating temperature is from wherein the heating temperature is from 60 to 160° C.

51. The method of claim 49, wherein the seal obtained from the method has a bond strength of at least 0.5N/25 mm; wherein bond strength is measured according to the method described in the description.

52. The method of claim 47, wherein the refractive index of the dry coating is within 5% of the substrate; and/or wherein the refractive index of both the dry coating and the substrate is 1.45 to 1.60.

53. The method of claim 47, wherein the uncoated substrate has a total visible light transmittance of at least 80%; wherein total visible light transmittance is measured according to the method described in the description.

54. The method of claim 47, wherein the polysaccharide is a maltodextrin derived from corn and/or rice.

55. The method of claim 47, wherein the polysaccharide has a water solubility at 25° C. of at least 5% (w/w) based on the dry weight of the polysaccharide.

56. The method of claim 47, wherein the coating has at least 80% biorenewable content (BRC).

57. The method of claim 47, wherein the coating is compostable and/or recyclable; wherein compostable materials comply with ASTM D6400, point 6.2 and/or ASTM D6868, point 6.2.

58. The method of claim 47, wherein the coating has a print viscosity in the range of 5 to 15 seconds (DIN #4) or 5 to 20 cps @ 1000 1/s shear; wherein viscosity is measured according to the method described in the description.

59. The method of claim 47, wherein the coating provides a barrier to oxygen at 25° C. and 50% relative humidity of less than or equal to 100 cm³/m²/24 hours per μm.

60. The method of claim 47, wherein the coating further comprises one or more wetting additives, a crosslinker, a nanoclay, a plasticizer, or combinations thereof; wherein, when present, the crosslinker is selected from the group consisting of sodium tripolyphosphate, calcium chloride, and combinations thereof, and is present in an amount of 1 to 10 wt %; wherein, when present, the nanocaly is present in an amount of 1 to 10 wt %.

61. The method of claim 47, wherein the coating has a solids content of 5 to 80% (w/w).

62. The method of claim 47, wherein the coating comprises an organic co-solvent, which is an alcohol selected from the group consisting of methanol, ethanol, isopropanol, butanol, pentanol, hexanol, and combinations thereof; wherein the organic co-solvent is incorporated into the coating in an amount of 1 to 10 wt %.

63. The method of claim 47, wherein the glass transition temperature of the polysaccharide is 100 to 200° C.

64. The method of claim 47, wherein the coating is applied to the substrate with a coating thickness of 0.1 to 20 μm.

65. The method of claim 47, further comprising overprinting the coating with a material selected from the group consisting of inks, additional coatings, adhesives, and combinations thereof.

66. The method of claim 65, wherein the material is an additional coating that enhances the oxygen and/or moisture barrier properties of the substrate; and/or wherein the inks, additional coatings, adhesives, and combinations thereof have a biorenewable content (BRC) of at least 50%.

67. The method of claim 47, wherein the substrate comprises less than 20 wt % cellophane.

68. A printed article obtainable from the method of claim 47 and comprising one or more layers of coating on said substrate.

69. The article of claim 68, wherein the substrate is paper.

70. The article of claim 68, wherein the haze value is less than 70%, wherein haze is measured according to the method described in the description; and/or wherein the optical transmission is at least 80%, wherein optical transmission is measured according to the method described in the description.
